(19) United States
(12) Patent Application Publication
(10) Pub. No.: US 2013/0140957 A1
(43) Pub. Date: Jun. 6, 2013

(54) ENERGY SCAVENGING SYSTEM USING ELASTO-ELECTRIC PLATES

(71) Applicants: ROBERT O. MILLER, Kalispell, MT (US); Stephen A. Boyd, Manhasset, NY (US)

(72) Inventors: ROBERT O. MILLER, Kalispell, MT (US); Stephen A. Boyd, Manhasset, NY (US)

(21) Appl. No.: 13/311,631

(22) Filed: Dec. 6, 2011

(51) Int. Cl. H02N 2/18

(52) U.S. Cl. 310/339

(57) ABSTRACT

Embodiments of the present invention are generally related to an energy scavenging system using elasto-electric plates and methods thereof. In one embodiment of the present invention, an energy scavenging system comprises at least one piezoelectric region in a roadbed or walkway, wherein the piezoelectric region generates electric fields by the strain deformation from vehicles rolling over it or pedestrians stepping upon it; and at least one plate of a solid material embedded in the roadbed or walkway, wherein the plate is designed to sustain, transmit and guide elastic plate modes that are generated in the piezoelectric region and launched into the plate at a first location; wherein the elastic plate modes are guided laterally through the plate to a second location, at which they are converted to electrical energy by the piezoelectric effect.

### BACKGROUND

1. Field of the Invention

Embodiments of the present invention are generally related to an energy scavenging system using elasto-electric plates and methods thereof.

2. Description of the Related Art

Known technology includes the deployment of piezoelectric films over surfaces, either in single layers or in serially connected multiple layers, to harvest energy that is imparted into the surfaces by the compressive and frictional stress of objects impinging on them, which energy would otherwise dissipate into the environment around and under the surfaces.

One of the possible drawbacks of these devices is the cost and durability of conductive electrodes that must be present throughout the films to collect electric current from the electric fields that are generated by the piezoelectric effect. Another drawback is the complexity of interconnecting these electrodes in a manner that efficiently routes and aggregates the currents collected from excitation sources that occur as spikes that are randomly spaced in time, and of random duration, as is characteristic of roadway traffic or pedestrian movement. Still another drawback is the need for interconnection topologies that have sufficient redundancy that the whole system, or a significant part of it, is not disabled by a local failure or defect. Any such, redundancy would also have to avoid lowering the collection efficiency of an interconnection scheme designed to optimally harvest energy coming from random inputs.

There are various known methods of interconnecting and switching units of an energy-harvesting system in order to synchronize the local currents collected. Designing path redundancy in interconnections is also feasible. Both of these factors contribute significantly to cost and complexity, but it is not clear that they can be optimized independently.

Thus, there is a need for an energy scavenging system using elasto-electric plates and methods thereof.

### SUMMARY

Embodiments of the present invention are generally related to an energy scavenging system using elasto-electric plates and methods thereof. In many embodiments of the present invention, it is unnecessary to distribute electrodes and connections throughout films utilized therein. In further embodiments, the tasks of efficient current collection and providing path redundancy are made much simpler, or greatly alleviated, when compared to known solutions. Moreover, the quantities of costly specialized materials needed are greatly reduced.

In one embodiment of the present invention, an energy scavenging system comprises at least one piezoelectric region in a roadbed or walkway, wherein the piezoelectric region generates electric fields by the strain deformation from vehicles rolling over it or pedestrians stepping upon it; and at least one plate of a solid material embedded in the roadbed or walkway, wherein the plate is designed to sustain, transmit and guide elastic plate modes that are generated in the piezoelectric region and launched into the plate at a first location; wherein the elastic plate modes are guided laterally through the plate to a second location, at which they are converted to electrical energy by the piezoelectric effect.

In some embodiments, the at least one piezoelectric region transfers its vibrational energy into the plate, in the form of propagating plate modes. In other embodiments, the plate contains either an elasto-electric or electro-elastic material, whereby elastic and electric fields interact to form coupled propagating modes. In yet further embodiments, the piezoelectric region and the plate are one and the same object.

In additional embodiments, the at least one piezoelectric region comprises a plurality of piezoelectric regions, separated by non-piezoelectric regions. In other embodiments, the plurality of piezoelectric regions are arranged in a periodic array, so that the composite of the piezoelectric regions and the non-piezoelectric regions form an elastic crystal. In yet another embodiment, the periodic array has an orientation and spatial period such that the propagation of elastic modes is concentrated in specific directions that comprise gradients to equal frequency contours, which behavior is known by the term “supercollimation.”

In another embodiment, the plurality of piezoelectric regions, combined with the non-piezoelectric regions, together comprise the plate. In yet another embodiment, the plurality of piezoelectric regions are arranged in a spatially aperiodic array. Alternatively, in another embodiment, the aperiodic array is a quasi-periodic array. In a further embodiment, the plate is comprised of a plurality of regions of a first material that are embedded in a second material, and wherein the first material has a first set of constitutive parameters and the second material has a second set of constitutive parameters; and wherein the constitutive parameters of the first and second sets of may include elastic modulus, shear modulus, Poisson ratio, mass density, longitudinal wave velocity, shear wave velocity and piezoelectric coefficient.

In another embodiment, an energy scavenging system comprises at least one piezoelectric means and at least one plate embedded in a roadbed or walkway, wherein vehicles passing upon the roadbed, or pedestrians walking upon the walkway, generate both electrical field pulses by the piezoelectric means and elastic modes in the plate; and wherein the combination of the plate and the piezoelectric means is designed to sustain, transmit and guide bulk elastic plate modes in the plate; and wherein the elastic plate modes are guided laterally through, and towards at least one edge of the plate, at which the elastic plate modes are converted to electrical energy by a piezoelectric means. In a further embodiment, the elastic modes and the electrical fields form coupled elastic-electric modes.

In yet another embodiment, an energy scavenging system comprises a solid plate in a roadbed or a walkway and an array of patches of piezoelectric material distributed on top of the solid plate, where the solid plate consists of an array of a first solid material that is embedded in a second solid material; wherein the first solid material has a first mass density and a first elastic compliance, and the second solid material has a second mass density and a second elastic compliance; and wherein the plate sustains, transmits and guides elastic plate modes that are launched into the plate by the pressure impulse of vehicles passing over the patches of piezoelectric material; and wherein the elastic plate modes are guided laterally through the plate toward at least one edge of the roadbed or walkway; and wherein at least one piezoelectric region is near at least one edge of the roadbed or walkway, where the energy of the elastic modes is converted to electrical energy in the piezoelectric region.

In another embodiment, the array of first solid material is a spatially periodic array. In yet another embodiment, the periodic array has an orientation and spatial period such that the propagation of elastic modes is concentrated in specific directions that comprise gradients to equal frequency contours. In yet a further embodiment, the array of first solid material is a spatially aperiodic array. In an alternative embodiment, the array of piezoelectric patches is a spatially periodic array. In an additional embodiment, the array of piezoelectric patches is a spatially aperiodic array, and in another embodiment, the aperiodic array is a quasi-periodic array.

### BRIEF DESCRIPTION OF THE DRAWINGS

So the manner in which the above-recited features of the present invention can be understood in detail, a more particular description of embodiments of the present invention, briefly summarized above, may be had by reference to embodiments, which are illustrated in the appended drawings. It is to be noted, however, the appended drawings illustrate only typical embodiments of embodiments encompassed within the scope of the present invention, and, therefore, are not to be considered limiting, for the present invention may admit to other equally effective embodiments, wherein:

FIG. 1 depicts a general schematic of known prior art as applied specifically to automotive roadways in which a piezoelectric layer is used to harvest energy by converting mechanical energy of a passing vehicle into electrical energy;

FIG. 2 a magnified detail of an area of FIG. 1, where the piezoelectric layer is compressed;

FIG. 3 depicts schematic of an embodiment of the present invention, in which compressive energy from a passing vehicle is transmitted through a piezoelectric plate to electrodes near an edge of a roadway;

FIG. 4 depicts a schematic of an embodiment of the present invention, in which compressive energy from a passing vehicle is transmitted through a plate that consists in part of a periodic array of piezoelectric material to electrodes near an edge of a roadway;

FIG. 5 depicts a schematic of an embodiment of the present invention, in which compressive energy from a passing vehicle is transmitted through a plate that has a periodic array of patches of a piezoelectric material arranged upon it, to electrodes near an edge of a roadway; and

FIG. 6 depicts a schematic of an embodiment of the present invention, in which compressive energy from a passing vehicle is transmitted through a plate that is composed of a periodic array of regions of a first type of solid material that is embedded in a second type of solid material, which composite plate has an aperiodic array of patches of a piezoelectric material arranged upon it, where the elastic energy is transmitted to electrodes near an edge of a roadway.

The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include”, “including”, and “includes” mean including but not limited to. To facilitate understanding, like reference numerals have been used, where possible, to designate like elements common to the figures.

### DETAILED DESCRIPTION

Embodiments of the present invention are generally related to an energy scavenging system using elasto-electric plates and methods thereof.

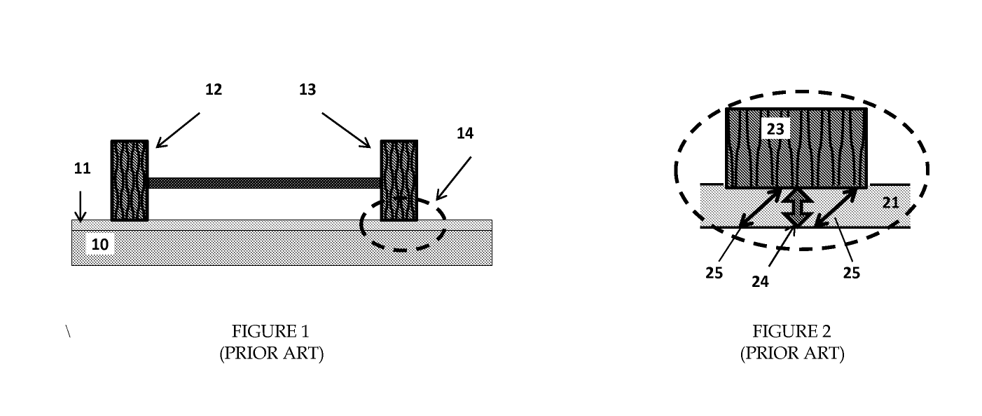

In FIG. 1, a schematic showing known prior art, wherein a layer 11 of a piezoelectric medium is deposited upon a roadway surface 10, and the tires 12 and 13 of a passing vehicle impart compressive stress to the film, which is thereby polarized with a field, and the charge that is displaced by the polarization is collected locally by conductive electrodes and carried away in external circuitry. As shown, there is a roadway 10 with piezoelectric layer 11 having vehicle tires 12, 13 rolling over the surface.

In FIG. 2, a magnified image of the circled region 14 in FIG. 1 is shown, wherein details of the piezoelectric response are indicated. The compressive stresses 24 of piezoelectric layer 21 are due to weight of tire 22 and the resultant electric polarization field 25, which is shown angularly displaced from the stress vector 24. The compressive stress 24 in the piezoelectric layer 21 from the tire 23 is shown to result in an electric polarization field 25 in the layer 21. As also depicted in the Figure, the direction of the polarization is not in general the same as that of the stress vector, and there is an angular displacement between the two.

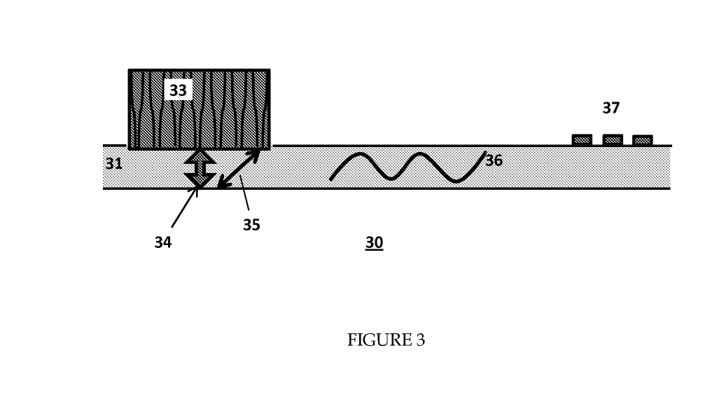

In FIG. 3, an embodiment of the present invention is depicted schematically, wherein compressive stress 34 from tire 33 on a layer 31 of a piezoelectric medium atop a roadway 30 is transmitted laterally through the film as an electro-elastic wave 36, set up and sustained by the coupling of elastic energy and electric polarization field 35. The electro-elastic wave 36 is terminated at the roadway edge, where an array 37 of electrodes extracts the energy in the form of electric current. Piezoelectric layer 31 is extended so that it serves as a planar waveguide for elastic waves 36 that propagate to the road edge, where the polarization fields they induce cause current to flow in an electrode array 37.

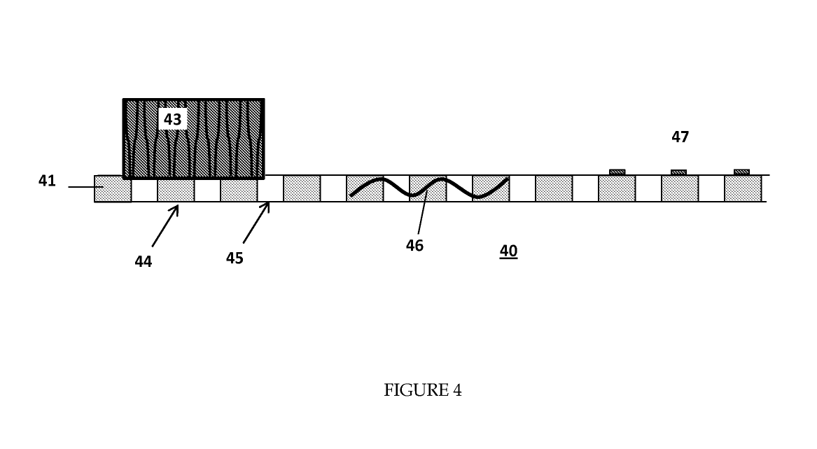

In FIG. 4, a second embodiment of the present invention is depicted schematically, which differs from that shown in FIG. 3 in that layer 41 is comprised of regions of piezoelectric solid material 44 that are embedded in a host solid material 45 that is not necessarily piezoelectric. The piezoelectric regions are centered on a periodic point lattice. An electro-elastic wave 46 generated by the compressive stress of tire 43 is transmitted by the composite layer 41 to the roadway edge, where an array 47 of electrodes extracts the energy in the form of electric current. Waveguiding layer 41 comprises a periodic array of piezoelectric regions 44 embedded in a non-piezoelectric host 45, and forming a planar waveguide, through which an elastic wave 46 propagates until its deformation is converted to electric current at electrodes 47.

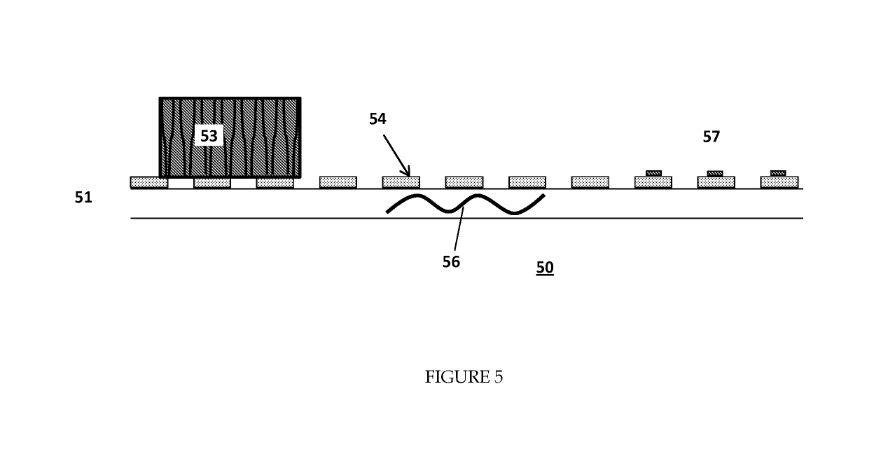

In FIG. 5, a third embodiment of the present invention is depicted schematically, which differs from that shown in FIG. 3 in that layer 51 is comprised of a solid material that is not necessarily piezoelectric. Regions of piezoelectric material 54, centered on a periodic point lattice, are disposed on top of layer 51. An electro-elastic wave 56, generated by the compressive stress of tire 53 in one or more of the piezoelectric regions 54, is transmitted by the layer 51 to the roadway edge, where an array 57 of electrodes, which are disposed on top of one or more piezoelectric regions 54, extracts the energy in the form of electric current. Waveguiding layer 51 comprises a solid plate of non-piezoelectrc material forming a planar waveguide, with patches of piezoelectric material 54 deposited on top, through which an elastic wave 56 propagates until its deformation is converted to electric current at electrodes 57.

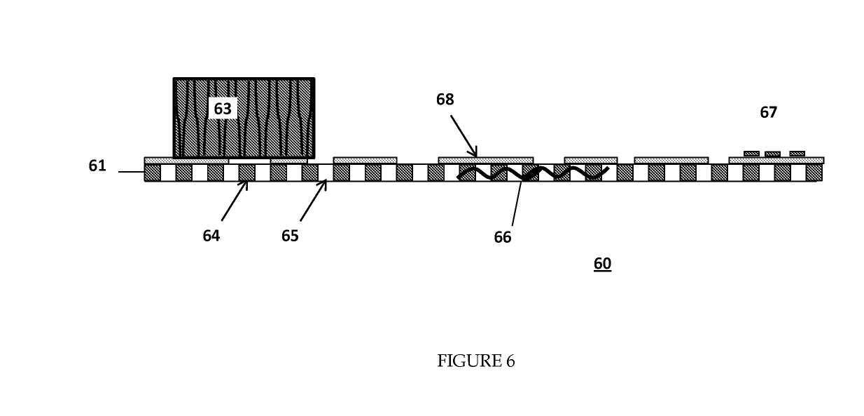

In FIG. 6, a fourth embodiment of the present invention is depicted schematically, which differs from that shown in FIG. 5 in that layer 61 is comprised of regions 64 of a first solid material that is not necessarily piezoelectric, which are embedded in, and periodically arranged in, a second solid material 65, which is not necessarily piezoelectric. The constitutive parameters of the two materials 64 and 65 differ in such a manner as to result in different elastic wave velocities within each one. For example, these constitutive parameters may consist of mass densities and compliances. Regions of piezoelectric material 68, are disposed on top of composite layer 61, and form an aperiodic array. An aperiodic array may be, for example, patches centered on the point lattice of a quasiperiodic tiling. Examples of quasiperiodic tilings are Penrose rhombs or Ammann-Beenker rhombs. An electro-elastic wave 66, generated by the compressive stress of tire 63 in one or more of the piezoelectric regions 68, is transmitted by the layer 61 to the roadway edge, where an array 67 of electrodes, which are disposed on top of one or more piezoelectric regions 68, extracts the energy in the form of electric current. Waveguiding layer 61 consists of a solid plate consisting of a material of a given density and stiffness periodically embedded in a material of another density and stiffness, forming a planar waveguide, with patches of piezoelectric material 68 deposited on top in a quasiperiodic pattern, through which an elastic wave 66 propagates until its deformation is converted to electric current at electrodes 67.

While the foregoing is directed to embodiments of the present invention, other and further embodiments of the invention may be devised without departing from the basic scope thereof. It is also understood that various embodiments described herein may be utilized in combination with any other embodiment described, without departing from the scope contained herein. In addition, embodiments of the present invention are further scalable to allow for additional clients and servers, as particular applications may require.

What is claimed is:

1. An energy scavenging system comprising:
at least one piezoelectric region in a roadbed or walkway, wherein the piezoelectric region generates electric fields by the strain deformation from vehicles rolling over it or pedestrians stepping upon it; and
at least one plate of a solid material embedded in the roadbed or walkway, wherein the plate is designed to sustain, transmit and guide elastic plate modes that are generated in the piezoelectric region and launched into the plate at a first location;
wherein the elastic plate modes are guided laterally through the plate to a second location, at which they are converted to electrical energy by the piezoelectric effect.

2. The system of claim 1, wherein the at least one piezoelectric region transfers its vibrational energy into the plate, in the form of propagating plate modes.

3. The system of claim 1, where the plate contains either an elasto-electric or electro-elastic material, whereby elastic and electric fields interact to form coupled propagating modes.

4. The system of claim 1, wherein the piezoelectric region and the plate are one and the same object.

5. The system of claim 1, where the at least one piezoelectric region comprises a plurality of piezoelectric regions, separated by non-piezoelectric regions.

6. The system of claim 5, where the plurality of piezoelectric regions are arranged in a periodic array, so that the composite of the piezoelectric regions and the non- piezoelectric regions form an elastic crystal.

7. The system of claim 6, wherein the periodic array has an orientation and spatial period such that the propagation of elastic modes is concentrated in specific directions that comprise gradients to equal frequency contours.

8. The system of claim 5, wherein the plurality of piezoelectric regions, combined with the non-piezoelectric regions, together comprise the plate.

9. The system of claim 5, wherein the plurality of piezoelectric regions are arranged in a spatially aperiodic array.

10. The system of claim 9, wherein the aperiodic array is a quasi-periodic array.

11. The system of claim 8, wherein the plate is comprised of a plurality of regions of a first material that are embedded in a second material, and wherein the first material has a first set of constitutive parameters and the second material has a second set of constitutive parameters; and
wherein the constitutive parameters of the first and second sets of may include elastic modulus, shear modulus, Poisson ratio, mass density, longitudinal wave velocity, shear wave velocity and piezoelectric coefficient.

12. An energy scavenging system comprising:
at least one piezoelectric means and at least one plate embedded in a roadbed or walkway, wherein vehicles passing upon the roadbed, or pedestrians walking upon the walkway, generate both electrical field pulses by the piezoelectric means and elastic modes in the plate; and
wherein the combination of the plate and the piezoelectric means is designed to sustain, transmit and guide bulk elastic plate modes in the plate; and
wherein the elastic plate modes are guided laterally through, and towards at least one edge of the plate, at which the elastic plate modes are converted to electrical energy by a piezoelectric means.

13. The system of claim 12, wherein the elastic modes and the electrical fields form coupled elastic-electric modes.

14. An energy scavenging system comprising:
a solid plate in a roadbed or a walkway and an array of patches of piezoelectric material distributed on top of the solid plate, where the solid plate consists of an array of a first solid material that is embedded in a second solid material;
wherein the first solid material has a first mass density and a first elastic compliance, and the second solid material has a second mass density and a second elastic compliance; and
wherein the plate sustains, transmits and guides elastic plate modes that are launched into the plate by the pressure impulse of vehicles passing over the patches of piezoelectric material; and
wherein the elastic plate modes are guided laterally through the plate toward at least one edge of the roadbed or walkway; and
wherein at least one piezoelectric region is near at least one edge of the roadbed or walkway, where the energy of the elastic modes is converted to electrical energy in the piezoelectric region.

15. The system of claim 14, wherein the array of first solid material is a spatially periodic array.

16. The system of claim 15, wherein the periodic array has an orientation and spatial period such that the propagation of elastic modes is concentrated in specific directions that comprise gradients to equal frequency contours.

17. The system of claim 14, wherein the array of first solid material is a spatially aperiodic array.

18. The system of claim 14, where the array of piezoelectric patches is a spatially periodic array.

19. The system of claim 14, where the array of piezoelectric patches is a spatially aperiodic array.

20. The system of claim 19, where the aperiodic array is a quasi-periodic array.
